(19) United States
(12) Patent Application Publication
(10) Pub. No.: US 2023/0205250 A1
(43) Pub. Date: Jun. 29, 2023

(54) SEMICONDUCTOR INTEGRATED CIRCUIT

(71) Applicant: ROHM CO., LTD., Kyoto (JP)

(72) Inventor: Masanobu TSUJI, Kyoto (JP)

(21) Appl. No.: 18/081,763

(22) Filed: Dec. 15, 2022

(30) Foreign Application Priority Data
Dec. 24, 2021 (JP) 2021-210828

(51) Int. Cl. G05F 3/26

(52) U.S. Cl. CPC G05F 3/262

(57) ABSTRACT

A semiconductor integrated circuit includes a current mirror circuit, wherein the current mirror circuit includes: an input node and an output node; a plurality of transistors; a switch circuit configured to be capable of selectively connecting each of the plurality of transistors to the input node or the output node; and a controller configured to control the switch circuit such that M (where M is an integer) transistors among the plurality of transistors are connected to the input node and N (where N is an integer) transistors among the plurality of transistors are connected to the output node, wherein the controller switches a combination of the M transistors and a combination of the N transistors in a time division manner.

### CROSS-REFERENCE TO RELATED APPLICATION

The present invention claims priority under 35 U.S.C. § 119 to Japanese Patent Application No. 2021-210828, filed on Dec. 24, 2021, the entire contents of which is incorporated herein by reference.

### TECHNICAL FIELD

The present disclosure relates to a current mirror circuit.

### BACKGROUND

A semiconductor integrated circuit uses a current mirror circuit to supply a current to a plurality of circuit blocks. In view of a demand for low power consumption, it is required to suppress an operating current of a circuit to a nanoampere order or a picoampere order in a sensor IC (Integrated Circuits), a power supply IC, and the like. In order to realize such an extremely small current in a state in which a gate-source voltage of a transistor of the current mirror circuit is higher than a threshold voltage, it is necessary to design a channel length L of a MOS transistor to be extremely long, which may cause an increase in the circuit area. Further, in a transistor model used in the design of the semiconductor integrated circuit, in a case where the channel length L becomes extremely long, the accuracy of the transistor model becomes low, which makes the design difficult.

An approach to solve this matter is to operate the transistor of the current mirror circuit in a sub-threshold region where the gate-source voltage is lower than the threshold voltage.

The present discloser has recognized that, in a current mirror circuit operating in a sub-threshold region to generate an extremely small current, an output current of the current mirror circuit contains noise which changes stepwise over time and the noise is RTN (Random Telegraph Noise).

The RTN is a characteristic fluctuation of a transistor in which a channel current fluctuates due to electron capture (electron trap) and electron release (electron de-trap or hole trap) occurring in insulating film defects of a MOS (Metal Oxide Semiconductor) transistor. Conventionally, it has been reported that the RTN affects characteristics in fine processes in which transistor elements such as CMOS image sensors, flash memories, and SRAMs (Static Random Access Memories) are highly integrated.

However, the present discloser has independently recognized that even in a current mirror circuit which is not constructed by a process as fine as an image sensor or a memory, an influence of the RTN becomes significant when handling an extremely small current. This recognition should not be taken as common to those skilled in the art.

When the influence of the RTN becomes significant in the current mirror circuit, the output current of the current mirror circuit is changed randomly over time. For example, when the output current of the current mirror circuit is used as a reference current of an oscillator, the RTN may cause a frequency of the oscillator to fluctuate.

### SUMMARY

Some embodiments of the present disclosure provide a current mirror circuit capable of suppressing an influence of RTN.

According to an embodiment of the present disclosure, a semiconductor integrated circuit includes a current mirror circuit. The current mirror circuit includes: an input node and an output node; a plurality of transistors; a switch circuit configured to be capable of selectively connecting each of the plurality of transistors to the input node or the output node; and a controller configured to control the switch circuit such that M (where M is an integer) transistors among the plurality of transistors are connected to the input node and N (where N is an integer) transistors among the plurality of transistors are connected to the output node, and the controller switches a combination of the M transistors and a combination of the N transistors in a time division manner.

Arbitrary combinations of the above constituent elements, and mutual replacement of the constituent elements and expressions among methods, devices, systems, and the like are also effective as embodiments of the present disclosure. Furthermore, the description in this section (SUMMARY) does not recite all the essential features of the present disclosure, and thus subcombinations of the recited features may also constitute the present disclosure.

### BRIEF DESCRIPTION OF DRAWINGS

The accompanying drawings, which are incorporated in and constitute a part of the specification, illustrate embodiments of the present disclosure.

FIG. 1 is a circuit diagram of a semiconductor integrated circuit including a current mirror circuit according to a first embodiment of the present disclosure.

FIG. 2 is a circuit diagram showing a structure example of a first selector.

FIG. 3 is a circuit diagram showing another structure example of the first selector.

FIG. 4 is a diagram for explaining an example of an operation of the current mirror circuit shown in FIG. 1.

FIG. 5 is a diagram showing an example of control signals generated by a controller.

FIG. 6 is a diagram for explaining effects of the current mirror circuit shown in FIG. 1.

FIG. 7 is a circuit diagram of a semiconductor integrated circuit including a current mirror circuit according to a second embodiment of the present disclosure.

FIG. 8 is a circuit diagram showing a structure example of a first selector.

FIG. 9 is a circuit diagram of a current mirror circuit according to a third embodiment of the present disclosure.

FIG. 10 is a circuit diagram of a current mirror circuit according to a fourth embodiment of the present disclosure.

FIG. 11 is a circuit diagram of a current mirror circuit according to a fifth embodiment of the present disclosure.

FIG. 12 is a circuit diagram of a semiconductor integrated circuit according to a sixth embodiment of the present disclosure.

FIG. 13 is a circuit diagram of a semiconductor integrated circuit according to a seventh embodiment of the present disclosure.

FIG. 14 is a circuit diagram of a semiconductor integrated circuit according to an eighth embodiment of the present disclosure.

### DETAILED DESCRIPTION

### (Outline of Embodiments)

An outline of some exemplary embodiments of the present disclosure will be described. This outline presents, in simplified form, some concepts of one or more embodiments of the present disclosure for the purpose of basic understanding of the embodiments, as a prelude to the detailed description presented later. This outline is not intended to limit the scope of the present disclosure. This outline is not a comprehensive outline of all possible embodiments, and is not intended to identify key elements of all embodiments or delineate the scope of some or all embodiments. For the sake of convenience, “an embodiment” may be used to refer to a single embodiment (example or variation) or a plurality of embodiments (examples or variations) disclosed herein.

A semiconductor integrated circuit according to an embodiment of the present disclosure includes a current mirror circuit. The current mirror circuit includes an input node, an output node, a plurality of transistors, a switch circuit configured to be capable of selectively connecting each of the plurality of transistors to the input node or the output node, and a controller configured to control the switch circuit such that M (where M is an integer) transistors among the plurality of transistors are connected to the input node and N (where N is an integer) transistors among the plurality of transistors are connected to the output node. The controller switches a combination of the M transistors and a combination of the N transistors in a time division manner.

According to this structure, by switching the structure of the current mirror circuit at a speed faster than a current fluctuation speed due to RTN, it is possible to smooth the current fluctuation due to the RTN and suppress an influence of the RTN.

In an embodiment of the present disclosure, a current supplied to the input node may be less than 100 nA.

In an embodiment of the present disclosure, gates of the plurality of transistors may be connected to the input node, and sources of the plurality of transistors may be connected to a fixed voltage line. The switch circuit may include a plurality of first selectors corresponding to the plurality of transistors. Each of the first selectors may include a common port connected to a drain of the corresponding one of the transistors, a first port connected to the input node, and a second port connected to the output node. The controller may electrically connect the first port and the common port of the corresponding one of the first selectors when one of the transistors is connected to the input node, and may electrically connect the second port and the common port of the corresponding one of the first selectors when one of the transistors is connected to the output node.

In an embodiment of the present disclosure, when the controller switches a port to which one of the transistors is connected, the corresponding one of the first selectors may go through a state in which the common port is not electrically connected to the first port and the second port. As a result, it is possible to reliably suppress short-circuiting between the input node and the output node.

In an embodiment of the present disclosure, the current mirror circuit may further include an input resistor including a first terminal connected to the input node. Sources of the plurality of transistors may be connected to a fixed voltage line. The switch circuit may include a plurality of first selectors corresponding to the plurality of transistors and a plurality of second selectors corresponding to the plurality of transistors. Each of the first selectors may include a common port connected to a drain of the corresponding one of the transistors, a first port connected to a second terminal of the input resistor, and a second port connected to the output node. Each of the second selectors may include a common port connected to a gate of the corresponding one of the transistors, a first port connected to the input node, and a second port connected to the second terminal of the input resistor. The controller may electrically connect the first port and the common port of the corresponding one of the first selectors and may electrically connect the first port and the common port of the corresponding one of the second selectors when connecting one of the transistors to the input node. The controller may electrically connect the second port and the common port of the corresponding one of the first selectors and may electrically connect the second port and the common port of the corresponding one of the second selectors when connecting one of the transistors to the output node.

In an embodiment of the present disclosure, the current mirror circuit may further include a first resistor including a first terminal connected to a fixed voltage line, and a second resistor including a first terminal connected to the fixed voltage line. Gates of the plurality of transistors may be connected to the input node. The switch circuit may include a plurality of first selectors corresponding to the plurality of transistors and a plurality of third selectors corresponding to the plurality of transistors. Each of the first selectors may include a common port connected to a drain of the corresponding one of the transistors, a first port connected to the input node, and a second port connected to the output node. Each of the third selectors includes a common port connected to a source of the corresponding one of the transistors, a first port connected to a second terminal of the first resistor, and a second port connected to a second terminal of the second resistor. The controller may electrically connect the first port and the common port of the corresponding one of the first selectors and may electrically connect the first port and the common port of the corresponding one of the third selectors when connecting one of the transistors to the input node. The controller may electrically connect the second port and the common port of the corresponding one of the first selectors and may electrically connect the second port and the common port of the corresponding one of the third selectors when connecting one of the transistors to the output node.

In an embodiment of the present disclosure, the plurality of transistors may operate in a sub-threshold region.

In an embodiment of the present disclosure, a switching frequency of the switch circuit may be 1 kHz or higher.

In an embodiment of the present disclosure, the current mirror circuit may further include a first capacitor connected to the input node. In an embodiment of the present disclosure, the current mirror circuit may further include a second capacitor connected to the output node. The first capacitor and the second capacitor may mitigate an influence of charge feedthrough due to changes in channel charge.

In an embodiment of the present disclosure, the current mirror circuit may further include an output transistor connected to the output node, and an amplifier configured to control a gate voltage of the output transistor such that a voltage of the output node of the current mirror circuit is equal to a voltage of the input node of the current mirror circuit. As a result, drain-source voltages of an input-side transistor and an output-side transistor may be made uniform, thereby suppressing current fluctuations due to switching.

In an embodiment of the present disclosure, the current mirror circuit may further include a third capacitor connected between a gate and a source of the output transistor. This makes it possible to mitigate an influence of clock feedthrough due to switching of an arrangement of transistors.

In an embodiment of the present disclosure, the controller may switch a combination of M transistors and a combination of N transistors by DWA (Data Weighted Averaging).

In an embodiment of the present disclosure, the controller may randomly switch the combination of M transistors and the combination of N transistors.

In an embodiment of the present disclosure, the semiconductor integrated circuit may further include an oscillator. An output current of the current mirror circuit may be supplied to the oscillator as a reference current. As a result, fluctuations in the reference current of the oscillator are suppressed, which makes it possible to stabilize an oscillation frequency of the oscillator.

In an embodiment of the present disclosure, the controller may operate in response to an oscillation signal of the oscillator.

In an embodiment of the present disclosure, the current mirror circuit may be incorporated into a current source.

### (Embodiments)

Embodiments of the present disclosure will be described below with reference to the drawings. The same or equivalent constituent elements, members, and processes shown in each drawing are denoted by the same reference numerals, and redundant description thereof will be omitted as appropriate. Moreover, the embodiments are illustrative of rather than limiting the present disclosure. Not all features or combinations thereof described in the embodiments are necessarily essential to the present disclosure.

In the present disclosure, “a state where a member A is connected to a member B” includes a case where the member A and the member B are physically and directly connected or even a case where the member A and the member B are indirectly connected through any other member that does not substantively affect an electrical connection state between the members A and B or does not impair functions and effects achieved by combinations of the members A and B.

Similarly, “a state where a member C is connected (installed) between a member A and a member B” includes a case where the member A and the member C or the member B and the member C are indirectly connected through any other member that does not substantively affect an electrical connection state between the members A and C or the members B and C or does not impair function and effects achieved by combinations of the members A and C or the members B and C, in addition to a case where the member A and the member C or the member B and the member C are directly connected.

### First Embodiment

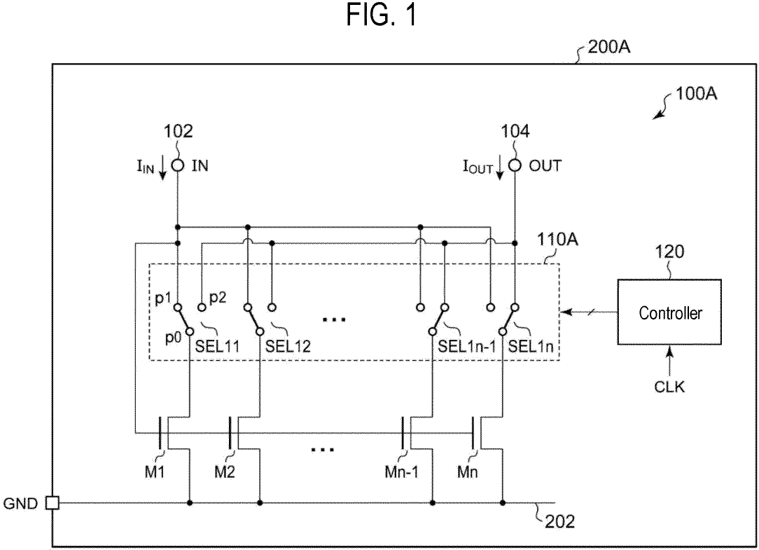

FIG. 1 is a circuit diagram of a semiconductor integrated circuit 200A including a current mirror circuit 100A according to a first embodiment of the present disclosure.

The semiconductor integrated circuit 200A includes a ground pin GND, a ground line (fixed voltage line) 202, and a current mirror circuit 100A.

The current mirror circuit 100A copies to return an input current I_{IN} supplied to an input node 102, and supplies an output current I_{OUT} to a circuit (not shown) connected to an output node 104. A mirror ratio of the current mirror circuit 100A is M:N. A relationship of I_{OUT}=N/M×I_{IN} is established. RTN becomes noticeable in a very small current region. For example, the current I_{IN} supplied to the input node 102 is less than 100 nA.

The current mirror circuit 100A includes an input node 102, an output node 104, a plurality of, e.g., n (n≧2), transistors M1 to Mn, a switch circuit 110A, and a controller 120.

The transistors M1 to Mn are NMOS transistors with the same size, each of which includes a gate connected to the input node 102 and a source connected to a ground line 202, which is a fixed voltage line.

The switch circuit 110A is configured to be capable of connecting a drain of each of transistors M1 to Mn to the input node 102 or the output node 104 of the current mirror circuit 100A.

For example, the switch circuit 110A includes a plurality of first selectors SELl1 to SELln corresponding to the plurality of transistors M1 to Mn. The i-th (1≤i≤n) first selector SELli includes a common port p0, a first port p1, and a second port p2. The common port p0 is connected to the drain of the corresponding transistor Mi, the first port p1 is connected to the input node 102, and the second port p2 is connected to the output node 104.

When one transistor Mi is connected to the input node 102, the controller 120 electrically connects the first port p1 and the common port p0 of the corresponding first selector SELli. Further, when one transistor Mi is connected to the output node 104, the controller 120 electrically connects the second port p2 and the common port p0 of the corresponding first selector SELli.

The controller 120 controls the switch circuit 110A such that M (where M is an integer) transistors among the plurality of transistors M1 to Mn are connected to the input node 102, and N (where N is an integer) transistors among the plurality of transistors M1 to Mn are connected to the output node 104. For example, a clock CLK may be inputted to the controller 120, and a state of the switch circuit 110A may be changed in synchronization with the clock CLK.

In the embodiment of the present disclosure, it is assumed that n=M+N and each transistor is constantly connected to either the input node 102 or the output node 104.

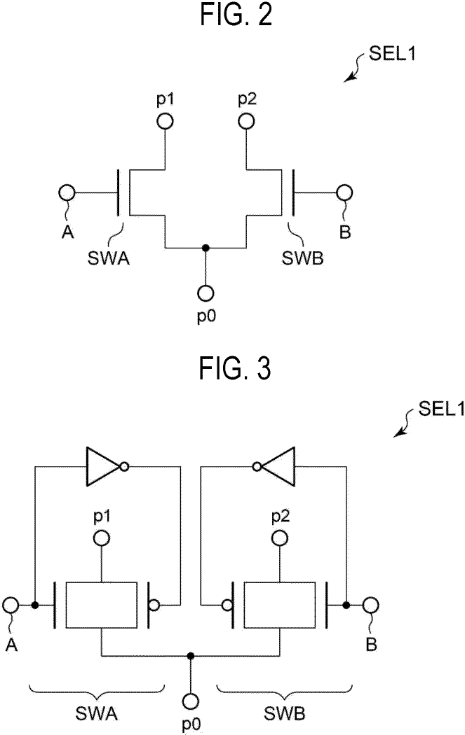

FIG. 2 is a circuit diagram showing a structure example of the first selector SELl. The first selector SELl includes a switch SWA and a switch SWB. The switch SWA is connected between the first port p1 and the common port p0, and the switch SWB is connected between the second port p2 and the common port p0.

In FIG. 2, the switches SWA and SWB are NMOS switches. When the control port A is high and the control port B is low, the switch SWA is on and the switch SWB is off. Conversely, when the control port B is high and the control port A is low, the switch SWA is off and the switch SWB is on.

FIG. 3 is a circuit diagram showing another structure example of the first selector SELl. The first selector SELl includes two switches SWA and SWB as in FIG. 2. In FIG. 3, the two switches SWA and SWB are CMOS switches.

The structure of the current mirror circuit 100A has been described above. Next, an operation thereof will be described.

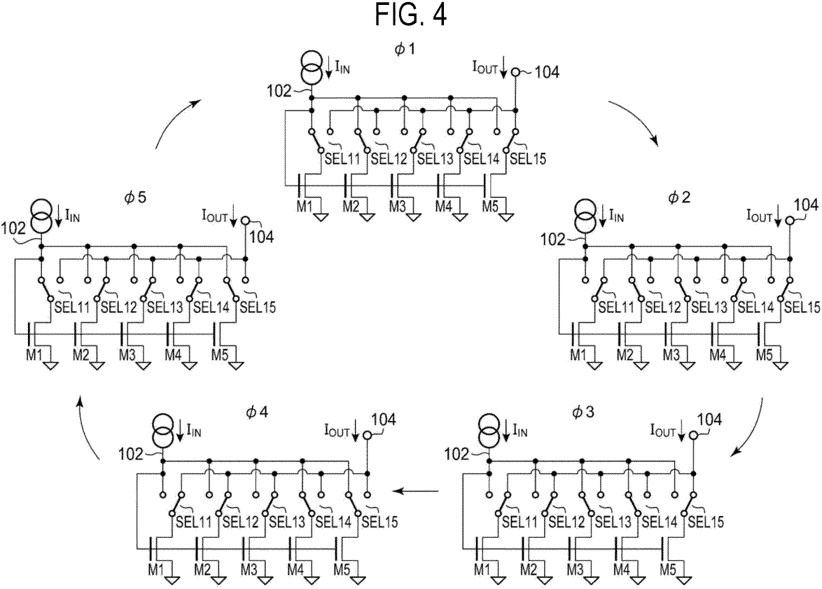

FIG. 4 is a diagram for explaining an example of the operation of the current mirror circuit 100A shown in FIG. 1. In FIG. 1, it is assumed that n=5, M=2, and N=3.

In this example, the current mirror circuit 100A cyclically transitions among five states φ1 to φ5. In the states φ1 to φ5, when the two transistors M1 and M5 at both ends are assumed to be adjacent to each other, the two adjacent transistors are connected to the input node 102, and the other three adjacent transistors are connected to the output node 104. Specifically, the states φ1 to φ5 are as follows.
φ1: The transistors M1 and M2 are connected to the input node 102, and the transistors M3, M4 and M5 are connected to the output node 104.
φ2: The transistors M2 and M3 are connected to the input node 102, and the transistors M4, M5 and M1 are connected to the output node 104.
φ3: The transistors M3 and M4 are connected to the input node 102, and the transistors M5, M1 and M2 are connected to the output node 104.
φ4: The transistors M4 and M5 are connected to the input node 102, and the transistors M1, M2 and M3 are connected to the output node 104.
φ5: The transistors M5 and M1 are connected to the input node 102, and the transistors M2, M3 and M4 are connected to the output node 104.

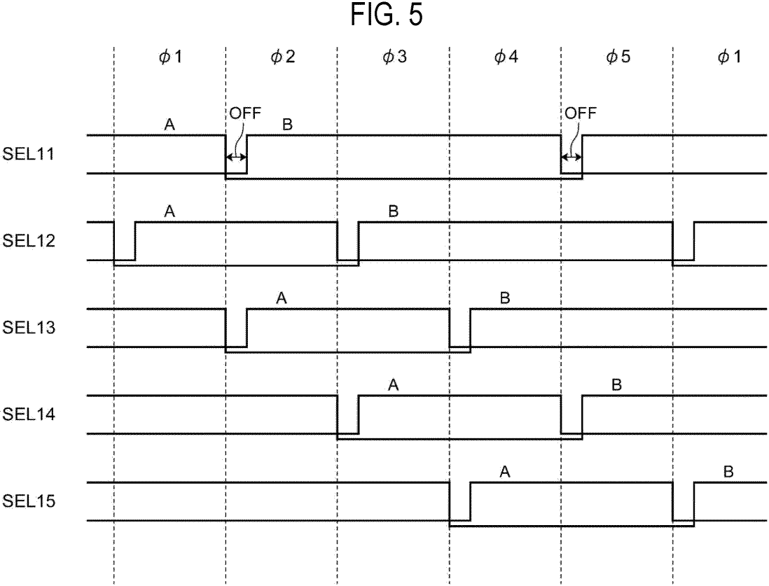

The controller 120 sequentially switches the states φ1 to φ5 in synchronization with the clock CLK. FIG. 5 is a diagram showing an example of control signals generated by the controller 120. In each first selector SELl, a section in which the control signal A is high is a state in which each first selector SELl is connected to the input port, and a section in which the control signal B is high is a state in which each first selector SELl is connected to the output port. When the control signals A and B transition, an off state OFF is inserted in which the control signals A and B are low at the same time. By inserting the off state OFF, it is possible to prevent short-circuiting between the two ports p1 and p2 of the first selector SELl, i.e., between the input node 102 and the output node 104 of the current mirror circuit 100A.

A method of generating the control signals is not particularly limited, and the controller 120 may include a logic circuit. For example, the controller 120 may generate an A-phase clock with a duty cycle of 40% (M/(M+N)) and a B-phase clock having an opposite phase to the A-phase clock and not overlapping with the A-phase clock, and may supply multi-phase clocks obtained by phase-shifting the A-phase clock and the B-phase clock to the plurality of first selectors SELl. From another point of view, the control in FIG. 5 may be said to be based on a DWA (Data Weighted Averaging) algorithm.

The above-described operation is an example of the operation of the current mirror circuit 100A.

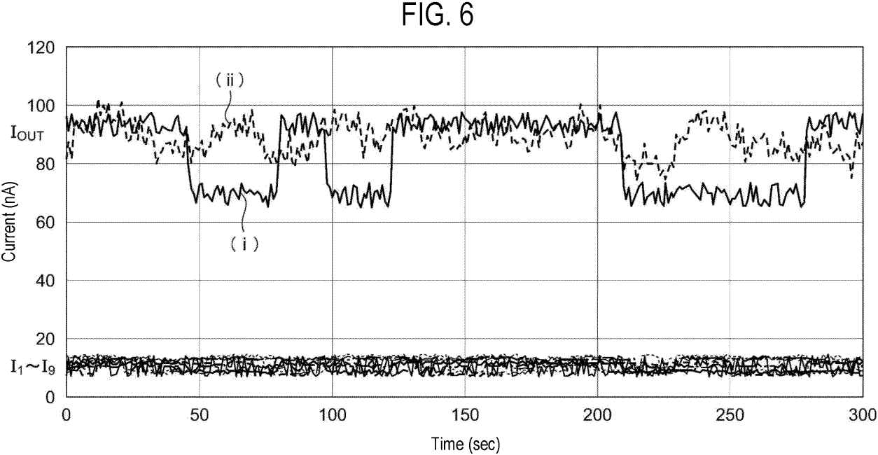

FIG. 6 is a diagram for explaining effects of the current mirror circuit 100A shown in FIG. 1. Here, it is assumed that n=9, M=1, and N=8. Currents I₁ to I₉ indicate currents I₁ to I₉ flowing through the transistors M1 to M9, respectively. Each current fluctuates over time due to influence of RTN and other noise. A waveform (i) indicates the output current I_{OUT} of the current mirror circuit when the transistor M1 is fixed on the input side and the transistors M2 to M9 are fixed on the output side. In this case, the output current I_{OUT} has a waveform obtained by multiplying the current I₁ by eight. In this case, eight times the effect of RTN of the current I₁ appear in the output current I_{OUT}.

The waveform (ii) indicates the output current I_{OUT} of the current mirror circuit 100A according to the embodiment of the present disclosure. Among the transistors M1 to M9, the transistor connected to the input side is switched in a time division manner. When the i-th transistor Mi is inputted, the output current I_{OUT} is eight times the current Ii. By switching the transistor connected to the input side sufficiently faster than the frequency of RTN, random noise is averaged and the influence of RTN may be reduced.

### Second Embodiment

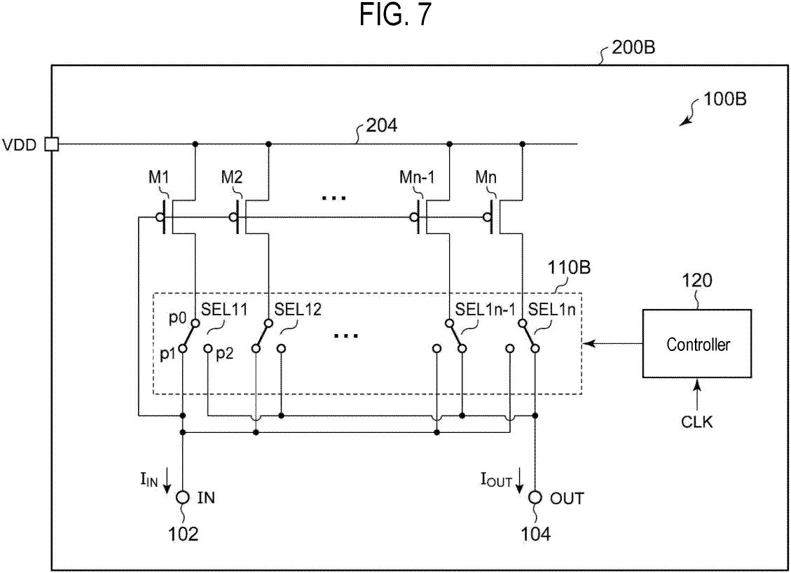

FIG. 7 is a circuit diagram of a semiconductor integrated circuit 200B provided with a current mirror circuit 100B according to a second embodiment of the present disclosure.

The semiconductor integrated circuit 200B includes a power supply pin VDD, a power supply line (fixed voltage line) 204, and a current mirror circuit 100B.

The current mirror circuit 100B copies to return the input current I_{IN} supplied to an input node 102, and supplies an output current I_{OUT} to a circuit (not shown) connected to an output node 104. A mirror ratio of the current mirror circuit 100B is M:N. A relationship of I_{OUT}=N/MXI_{IN} is established.

The basic structure of the current mirror circuit 100B is the same as that of the current mirror circuit 100A shown in FIG. 1, and is vertically inverted with respect to that of the current mirror circuit 100A shown in FIG. 1. Specifically, the current mirror circuit 100B includes an input node 102, an output node 104, a plurality of, e.g., n (n≧2), transistors M1 to Mn, a switch circuit 110B, and a controller 120.

The transistors M1 to Mn are PMOS transistors with the same size, each gate of which is connected to the input node 102, and each source of which is connected to the power supply line 204, which is a fixed voltage line.

The switch circuit 110B is configured to be capable of connecting the drains of the transistors M1 to Mn to the input node 102 or the output node 104 of the current mirror circuit 100B.

The switch circuit 110B includes a plurality of first selectors SELl1 to SELln corresponding to the transistors M1 to Mn.

The controller 120 controls the switch circuit 110B such that M (where M is an integer) transistors among the plurality of transistors M1 to Mn are connected to the input node 102, and N (where N is an integer) transistors among the plurality of transistors M1 are connected to the output node 104. In this embodiment, it is assumed that n=M+N and each transistor is constantly connected to either the input node 102 or the output node 104.

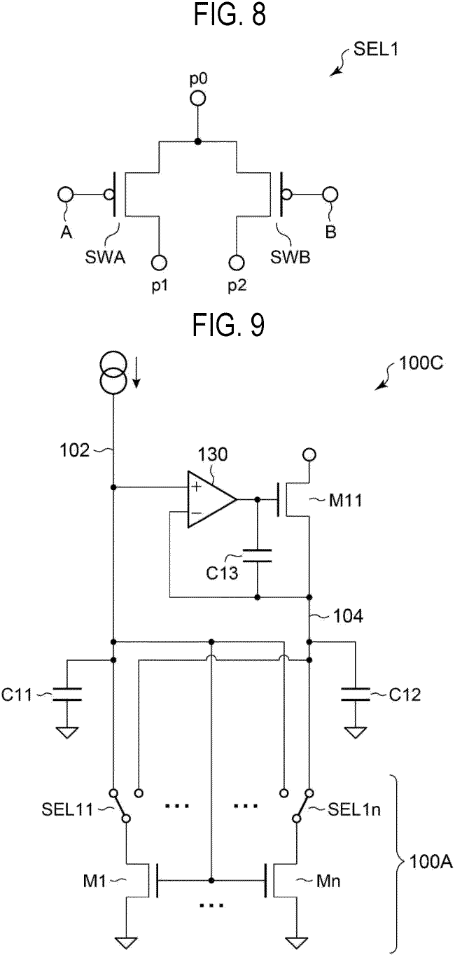

FIG. 8 is a circuit diagram showing a structure example of the first selector SELl of the switch circuit 110B. The first selector SELl includes a switch SWA and a switch SWB. The switches SWA and SWB are PMOS switches. The first selector SELl of the switch circuit 110B shown in FIG. 7 may be constituted by the CMOS switch shown in FIG. 3.

According to the second embodiment, the same effects as those of the first embodiment may be obtained.

### (Third Embodiment)

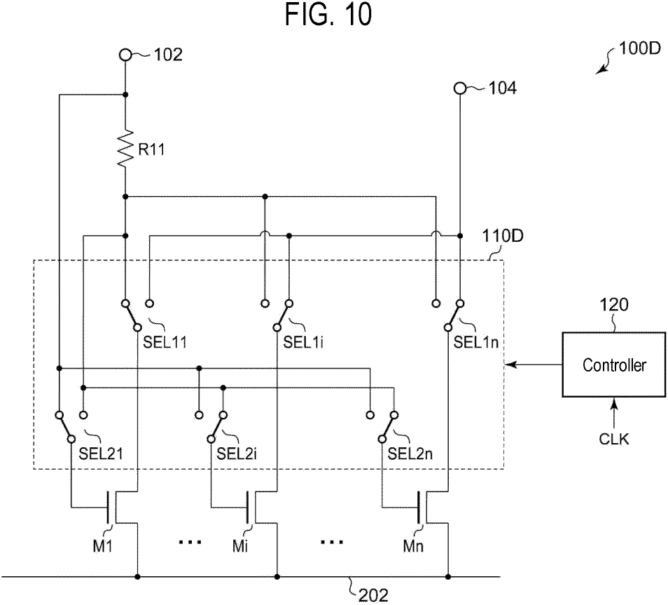

FIG. 9 is a circuit diagram of a current mirror circuit 100C according to a third embodiment of the present disclosure.

The current mirror circuit 100C further includes an output transistor M11, an amplifier 130, and capacitors C11 to C13 in addition to the current mirror circuit 100A shown in FIG. 1.

An output transistor M11 is connected to the output node 104. The amplifier 130 includes a first input terminal (+) connected to the input node 102 and a second input terminal (-) connected to the output node 104. The output terminal of the amplifier 130 is connected to a gate of the output transistor M11. The amplifier 130 controls a gate voltage of the output transistor M11 such that a voltage Vo of the output node 104 is equal to a voltage Vi of the input node 102.

As a result, drain-source voltages of the input-side transistors and the output-side transistors may be made uniform, thereby suppressing current fluctuations due to switching.

The first capacitor C11 is connected to the input node 102, and the second capacitor C12 is connected to the output node 104. The first capacitor C11 and the second capacitor C12 may mitigate the influence of charge feedthrough due to changes in channel charge.

The third capacitor C13 is connected between the gate and source of the output transistor M11. This makes it possible to mitigate the influence of clock feedthrough due to switching of the arrangement of the transistors.

A structure in which the current mirror circuit 100C shown in FIG. 9 is inverted vertically, that is, a structure in which an output transistor, an amplifier, and a capacitor are added to the current mirror circuit 100B shown in FIG. 7, is also considered as one form of the present disclosure.

### (Fourth Embodiment)

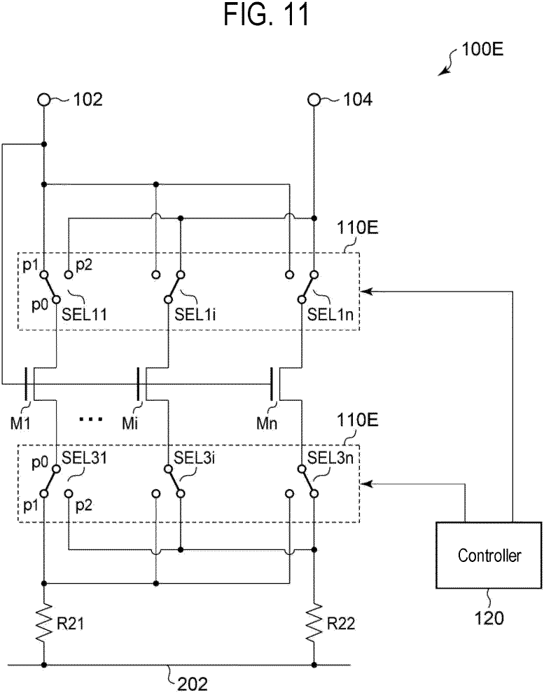

FIG. 10 is a circuit diagram of a current mirror circuit 100D according to a fourth embodiment of the present disclosure. The current mirror circuit 100D is called a Nagata current mirror circuit and includes an input resistor R11. A first terminal of the input resistor R11 is connected to an input node 102.

The switch circuit 110D includes a plurality of first selectors SEL11 to SEL1n corresponding to a plurality of transistors M1 to Mn and a plurality of second selectors SEL21 to SEL2n corresponding to the transistors M1 to Mn.

An i-th (1≤i≤n) first selector SELli includes a common port p0 connected to a drain of the corresponding transistor Mi, a first port p1 connected to a second terminal of the input resistor R11, and a second port p2 connected to an output node 104.

An i-th (1≤i≤n) second selector SEL2i includes a common port p0 connected to a gate of the corresponding transistor Mi, a first port p1 connected to the input node 102, and a second port p2 connected to the second terminal of the input resistor R11.

When one transistor Mi is connected to the input node 102, the controller 120 electrically connects the first port p1 and the common port p0 of the corresponding first selector SELli, and electrically connects the first port p1 and the common port p0 of the corresponding second selector SEL2i. Conversely, when one transistor Mi is connected to the output node 104, the controller 120 electrically connects the second port p2 and the common port p0 of the corresponding first selector SELli, and electrically connects the second port p2 and the common port p0 of the corresponding second selector SEL2i.

### (Fifth Embodiment)

FIG. 11 is a circuit diagram of a current mirror circuit 100E according to a fifth embodiment of the present disclosure. The current mirror circuit 100E is called a β multiplication current mirror circuit, and includes a first resistor R21 and a second resistor R22 inserted near a source (near a fixed voltage line). A first terminal of the first resistor R21 and a first terminal of the second resistor R22 are connected to a ground line 202, which is a fixed voltage line.

The switch circuit 110E includes a plurality of first selectors SELl1 to SELln corresponding to a plurality of transistors M1 to Mn and a plurality of third selectors SEL31 to SEL3n corresponding to the transistors M1 to Mn.

An i-th (1≤i≤n) first selector SELli includes a common port p0 connected to a drain of the corresponding transistor Mi, a first port p1 connected to a second terminal of an input resistor R11, and a second port p2 connected to an output node 104.

An i-th (1≤i≤n) third selector SEL3i includes a common port p0 connected to a source of the corresponding transistor Mi, a first port p1 connected to a second terminal of the first resistor R21, and a second port p2 connected to a second terminal of the second resistor R22.

When one transistor Mi is connected to the input node 102, the controller 120 electrically connects the first port p1 and the common port p0 of the corresponding first selector SELli, and electrically connects the first port p1 and the common port p0 of the corresponding third selector SEL3i. Conversely, when one transistor Mi is connected to the output node 104, the controller 120 electrically connects the second port p2 and the common port p0 of the corresponding first selector SELli, and electrically connects the second port p2 and the common port p0 of the corresponding third selector SEL3i.

Next, modifications of the current mirror circuit will be described.

### (First Modification)

The operation of the current mirror circuit 100 is not limited to that described with reference to FIG. 4. For example, in the example of n=5 shown in FIG. 4, the five states φ1 to φ5 may be transitioned in a predetermined order different from that shown in FIG. 4, or the five states φ1 to φ5 may be randomly switched.

In the example of n=5 shown in FIG. 4, there is a total of ₅C₂=10 states in which two transistors are connected to the input node and three transistors are connected to the output node. ₙCₘ is an operator that indicates a combination obtained by selecting m out of n. A state to be used may be arbitrarily selected from ten states.

### (Second Modification)

Although the example of n=M+N has been described in the embodiments of the present disclosure, n>M+N may be adopted. In this case, in each time slot of time-division control, n-(M+N) transistors may be in an off state in which they are not connected to either the input node 102 or the output node 104.

### (Third Modification)

Although the current mirror circuit with one output has been described in the embodiments of the present disclosure, the present disclosure may also be applied to a current mirror circuit with two or more outputs. For example, a current mirror circuit with two outputs includes one input node and two output nodes. The number of transistors satisfies n≧M+N+K. The controller controls the switch circuit such that M transistors among the n transistors are connected to an input node, N transistors among the n transistors are connected to a first output node, and K transistors among the n transistors are connected to a second output node.

### (Fourth Modification)

The current mirror circuits 100D and 100E shown in FIGS. 10 and 11 may be inverted vertically. Further, in the current mirror circuit 100E shown in FIG. 11, one of the first resistor R21 and the second resistor R22 may be omitted.

Next, application of the current mirror circuit will be explained. Hereinafter, the current mirror circuits 100A to 100E and their modifications are designated simply by reference numeral 100. The current mirror circuit 100 is also called a chopping current mirror circuit.

### (Sixth Embodiment)

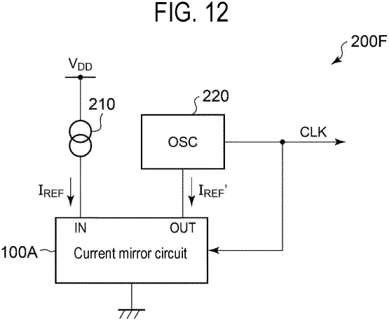

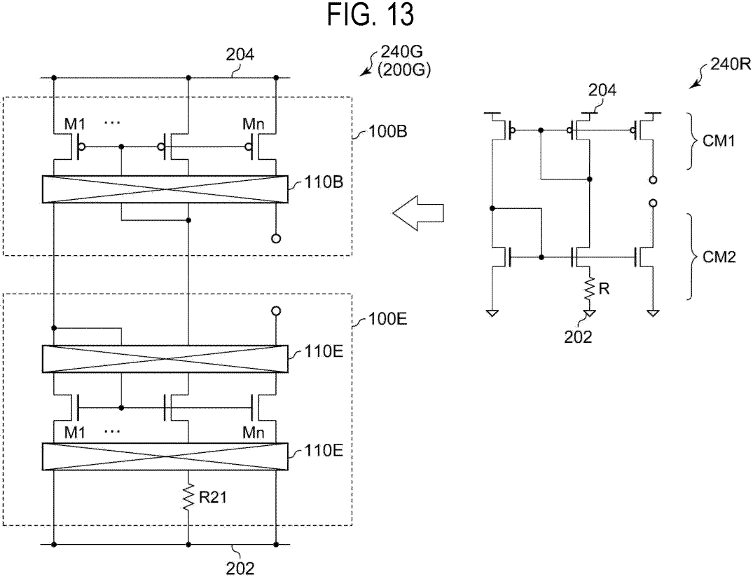

FIG. 12 is a circuit diagram of a semiconductor integrated circuit 200F according to a sixth embodiment of the present disclosure. The semiconductor integrated circuit 200F includes the current mirror circuit 100 of FIG. 1, a reference current source 210, and an oscillator 220. The reference current source 210 generates a reference current I_{REF}. The current mirror circuit 100 receives the reference current I_{REF} as an input current I_{IN} at its input node 102, and copies to return the reference current I_{REF} thus received. The oscillator 220 is connected to the output node 104 of the current mirror circuit 100. The output current I_{OUT} of the current mirror circuit 100 is a reference current I_{REF}′ obtained by multiplying the reference current I_{REF} by a constant, and is supplied to the oscillator 220. The oscillator 220 oscillates at a frequency corresponding to the reference current I_{REF}′. A structure of the oscillator 220 is not particularly limited. For example, the oscillator 220 may be a ring oscillator that includes a plurality of inverters biased by the reference current I_{REF}′. Alternatively, the oscillator 220 may be an RC-ring oscillator formed by adding an RC filter to the ring oscillator. Alternatively, the oscillator 220 may be a relaxation oscillator that charges and discharges a capacitor with a current based on the reference current I_{REF}′, or may be an RC relaxation oscillator.

With this structure, the RTN of the reference current I_{REF}′ supplied to the oscillator 220 is suppressed, which makes it possible to stabilize an oscillation frequency of the oscillator 220.

In FIG. 12, the clock CLK generated by the oscillator 220 may be supplied to the controller 120 of the current mirror circuit 100.

### (Seventh Embodiment)

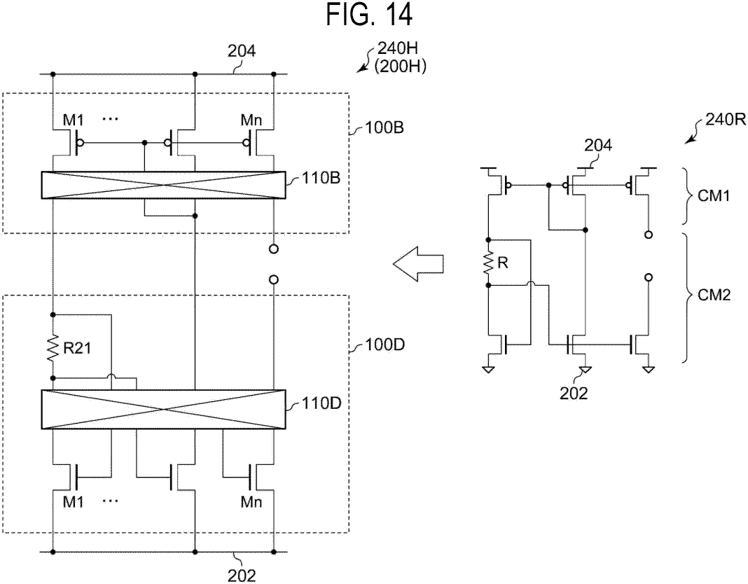

FIG. 13 is a circuit diagram of a semiconductor integrated circuit 200G according to a seventh embodiment of the present disclosure. The semiconductor integrated circuit 200G includes a reference current source 240G that generates a reference current I_{REF}. This reference current source 240G may be, for example, the reference current source 210 shown in FIG. 12.

On the right side in FIG. 13, a basic structure of the reference current source (240R) is shown. The reference current source 240R includes a current mirror circuit CM1 near a power supply line 204 and a current mirror circuit CM2 near a ground line 202. A resistor R11 is inserted between the transistor on the output side of the current mirror circuit CM2 and the ground line 202. The current mirror circuits CM1 and CM2 are connected such that an output current of one of the current mirror circuits CM1 and CM2 becomes an input current of the other of the current mirror circuits CM1 and CM2.

The reference current source 240G according to the seventh embodiment is obtained by forming the current mirror circuits CM1 and CM2 with chopping current mirror circuits. The current mirror circuit CM1 on the upper side may be formed by the current mirror circuit 100B shown in FIG. 7 (or its modification). The current mirror circuit CM2 on the lower side may be formed in such a structure that R21 is omitted from the current mirror circuit 100E shown in FIG. 11.

### (Eighth Embodiment)

FIG. 14 is a circuit diagram of a semiconductor integrated circuit 200H according to an eighth embodiment of the present disclosure. The semiconductor integrated circuit 200H includes a reference current source 240H that generates a reference current I_{REF}.

On the right side in FIG. 14, a basic configuration of a reference current source (240S) is shown. The reference current source 240S includes a current mirror circuit CM1 near a power supply line 204 and a current mirror circuit CM2 near a ground line 202. The current mirror circuit CM2 is a Nagata current mirror circuit.

In the reference current source 240H according to the eighth embodiment, the current mirror circuits CM1 and CM2 are constituted by chopping current mirror circuits. The current mirror circuit CM1 on the upper side may be constituted by the current mirror circuit 100B shown in FIG. 7 (or its modification). The current mirror circuit CM2 on the lower side may be constituted by the current mirror circuit 100D shown in FIG. 10.

The embodiments of the present disclosure are examples, and those skilled in the art will understand that there are various modifications in the combinations of the respective components and the respective processing processes, and that such modifications are also included in the scope of the present disclosure.

According to the present disclosure in some embodiments, it is possible to suppress the influence of RTN.

While certain embodiments have been described, these embodiments have been presented by way of example only, and are not intended to limit the scope of the disclosures. Indeed, the embodiments described herein may be embodied in a variety of other forms. Furthermore, various omissions, substitutions, and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A semiconductor integrated circuit, comprising:
a current mirror circuit,
wherein the current mirror circuit includes:
an input node and an output node;
a plurality of transistors;
a switch circuit configured to be capable of selectively connecting each of the plurality of transistors to the input node or the output node; and
a controller configured to control the switch circuit such that M (where M is an integer) transistors among the plurality of transistors are connected to the input node and N (where N is the integer) transistors among the plurality of transistors are connected to the output node, and
wherein the controller switches a combination of the M transistors and a combination of the N transistors in a time division manner.

2. The semiconductor integrated circuit of claim 1, wherein a current supplied to the input node of the current mirror circuit is less than 100 nA.

3. The semiconductor integrated circuit of claim 1, wherein gates of the plurality of transistors are connected to the input node, and sources of the plurality of transistors are connected to a fixed voltage line,
wherein the switch circuit includes a plurality of first selectors corresponding to the plurality of transistors, each of the first selectors including:
a first port connected to the input node;
a second port connected to the output node; and
a common port connected to a drain of the corresponding one of the transistors, and
wherein when one of the transistors is connected to the input node, the controller electrically connects the first port and the common port of the corresponding one of the first selectors and when one of the transistors is connected to the output node, the controller electrically connects the second port and the common port of the corresponding one of the first selectors.

4. The semiconductor integrated circuit of claim 3, wherein when the controller switches a port to which one of the transistors is connected, the corresponding one of the first selectors goes through a state in which the common port is not electrically connected to the first port and the second port.

5. The semiconductor integrated circuit of claim 1, wherein the current mirror circuit further includes an input resistor including a first terminal connected to the input node,
wherein sources of the plurality of transistors are connected to a fixed voltage line,
wherein the switch circuit includes a plurality of first selectors corresponding to the plurality of transistors, and a plurality of second selectors corresponding to the plurality of transistors,
wherein each of the first selectors includes a first port connected to a second terminal of the input resistor, a second port connected to the output node, and a common port connected to a drain of the corresponding one of the transistors, wherein each of the second selectors includes a first port connected to the input node, a second port connected to the second terminal of the input resistor, and a common port connected to a gate of the corresponding one of the transistors,
wherein when one of the transistors is connected to the input node, the controller electrically connects the first port and the common port of the corresponding one of the first selectors and electrically connect the first port and the common port of the corresponding one of the second selectors, and
wherein when one of the transistors is connected to the output node, the controller electrically connects the second port and the common port of the corresponding one of the first selectors and electrically connects the second port and the common port of the corresponding one of the second selectors.

6. The semiconductor integrated circuit of claim 1, wherein the current mirror circuit further includes a first resistor including a first terminal connected to a fixed voltage line, and a second resistor including a first terminal connected to the fixed voltage line,
wherein gates of the plurality of transistors are connected to the input node,
wherein the switch circuit includes a plurality of first selectors corresponding to the plurality of transistors, and a plurality of third selectors corresponding to the plurality of transistors,
wherein each of the first selectors includes a first port connected to the input node, a second port connected to the output node, and a common port connected to a drain of the corresponding one of the transistors,
wherein each of the third selectors includes a first port connected to a second terminal of the first resistor, a second port connected to a second terminal of the second resistor, and a common port connected to a source of the corresponding one of the transistors,
wherein when one of the transistors is connected to the input node, the controller electrically connects the first port and the common port of the corresponding one of the first selectors and electrically connects the first port and the common port of the corresponding one of the third selectors, and
wherein when one of the transistors is connected to the output node, the controller electrically connects the second port and the common port of the corresponding one of the first selectors and electrically connects the second port and the common port of the corresponding one of the third selectors.

7. The semiconductor integrated circuit of claim 1, wherein the plurality of transistors operates in a sub-threshold region.

8. The semiconductor integrated circuit of claim 1, wherein a switching frequency of the switch circuit is 1 kHz or higher.

9. The semiconductor integrated circuit of claim 1, wherein the current mirror circuit further includes a first capacitor connected to the input node.

10. The semiconductor integrated circuit of claim 1, wherein the current mirror circuit further includes a second capacitor connected to the output node.

11. The semiconductor integrated circuit of claim 1, wherein the current mirror circuit further includes:
an output transistor connected to the output node; and
an amplifier configured to control a gate voltage of the output transistor such that a voltage of the output node of the current mirror circuit is equal to a voltage of the input node of the current mirror circuit.

12. The semiconductor integrated circuit of claim 11, wherein the current mirror circuit further includes a third capacitor connected between a gate and a source of the output transistor.

13. The semiconductor integrated circuit of claim 1, wherein the controller switches the M transistors connected to the input node by DWA (Data Weighted Averaging).

14. The semiconductor integrated circuit of claim 1, wherein the controller randomly switches the M transistors connected to the input node.

15. The semiconductor integrated circuit of claim 1, further comprising:
an oscillator,
wherein an output current of the current mirror circuit is supplied to the oscillator as a reference current.

16. The semiconductor integrated circuit of claim 15, wherein the controller operates in response to an oscillation signal of the oscillator.

17. The semiconductor integrated circuit of claim 1, wherein the current mirror circuit is incorporated into a current source.
